(19) United States
(12) Patent Application Publication
(10) Pub. No.: US 2026/0121576 A1
(43) Pub. Date: Apr. 30, 2026

(54) SYSTEMS, APPARATUSES, AND DEVICES FOR ADJUSTABLY MOUNTING A SOLAR PANEL

(71) Applicant: Sunnoo Inc., Las Cruces, NM (US)

(72) Inventor: Martin Anthony Gero, Las Cruces, NM (US)

(21) Appl. No.: 19/003,684

(22) Filed: Dec. 27, 2024

Related U.S. Application Data
(63) Continuation-in-part of application No. 18/302,616, filed on Apr. 18, 2023, now Pat. No. 12,199,551.
(60) Provisional application No. 63/332,104, filed on Apr. 18, 2022.

(51) Int. Cl. H02S 20/32; F16M 11/12; F16M 11/18; H02K 7/116; H02K 37/24

(52) U.S. Cl. CPC H02S 20/32; F16M 11/126; F16M 11/18; H02K 7/116; H02K 37/24

(57) ABSTRACT

An apparatus for adjustably mounting a solar panel. The apparatus includes a tilt housing defining an interior space extending between a tilt end and a base end of the tilt housing, a primary bearing disposed adjacent to the base end, and includes a first bearing ring fixedly coupled to the base end, and a second bearing ring, a swivel joint element, a mounting plate, a post, a rotating assembly, and secondary bearings. The swivel joint element is comprised in the interior space, and coupled to the first bearing ring. The mounting plate is disposed adjacent to the tilt end, and rotatably coupled with the swivel joint element. A first end of the post is fixedly coupled to the first bearing ring. The rotating assembly includes a motor, and attached to the post. The motor is operatively coupled with the primary bearing. The secondary bearings orientably supports the mounting plate.

### FIELD OF THE INVENTION

Generally, the present disclosure relates to the field of miscellaneous hardware. More specifically, the present disclosure relates to systems, apparatuses, and devices for adjustably mounting a solar panel.

### BACKGROUND OF THE INVENTION

Solar panel fixtures are often employed in photovoltaic farms, or solar panel systems attached onto buildings and structures. These fixtures range from roof fixtures to turrets, or wall brackets. Automated solar panel fixtures may also be employed, such that these automated solar panel fixtures position the solar panel to an optimal position for solar capture. These conventional systems often employ gearbox transmissions, servos, and other robotic parts to tilt or rotate the solar panels to the optimal position. These conventional systems, however, are complicated and expensive to produce, leading to higher margins of defects, higher susceptibility of parts breakage, higher maintenance upkeep, and overall higher costs to construct and maintain. As a result, an apparatus is needed to provide a mechanically efficient and cost effective automated solar panel turret fixture.

Therefore, there is a need for improved systems, apparatuses, and devices for adjustably mounting a solar panel that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is an apparatus for adjustably mounting a solar panel, in accordance with some embodiments. Accordingly, the apparatus may include a tilt housing, a primary bearing, a swivel joint element, a mounting plate, a post, a rotating assembly, and a plurality of secondary bearings. Further, the tilt housing may include a tilt end and a base end. Further, the tilt end and the base end are positioned terminally opposite to each other along the tilt housing. Further, the tilt housing defines an interior space extending between the tilt end and the base end. Further, the primary bearing may be disposed adjacent to the base end. Further, the primary bearing may include a first bearing ring and a second bearing ring. Further, the first bearing ring and the second bearing ring are rotatably engaged. Further, the second bearing ring may be fixedly coupled to the base end of the tilt housing. Further, the swivel joint element may be comprised in the interior space. Further, the swivel joint element may be coupled to the first bearing ring. Further, the mounting plate may be disposed adjacent to the tilt end. Further, the mounting plate may be rotatably coupled with the swivel joint element. Further, the mounting plate may be configured for mounting the solar panel on the mounting plate. Further, the post may include a first end and a second end. Further, the first end may be positioned opposite to the second end along the post. Further, the first end may be fixedly coupled to the first bearing ring. Further, the rotating assembly may include a motor. Further, the rotating assembly may be coupled to the post. Further, the motor may be operatively coupled with the primary bearing. Further, the plurality of secondary bearings may be attached around the tilt housing along a line parallel to the tilt edge. Further, the plurality of secondary bearings may be configured for orientably supporting the mounting plate rotatably coupled to the swivel joint element.

Further disclosed herein is an an apparatus for adjustably mounting a solar panel, in accordance with some embodiments. Accordingly, the apparatus may include a tilt housing, a primary bearing, a swivel joint element, a mounting plate, a post, a rotating assembly, and a plurality of secondary bearings. Further, the tilt housing may include a tilt end and a base end. Further, the tilt end and the base end are positioned terminally opposite to each other along the tilt housing. Further, the tilt housing defines an interior space extending between the tilt end and the base end. Further, the tilt housing may be circularly cylindrical shaped. Further, the tilt housing may include a tilt edge defining the tilt end. Further, the tilt edge may be beveled. Further, the primary bearing may be disposed adjacent to the base end. Further, the primary bearing may include a first bearing ring and a second bearing ring. Further, the first bearing ring and the second bearing ring are rotatably engaged. Further, the second bearing ring may be fixedly coupled to the base end of the tilt housing. Further, the swivel joint element may be comprised in the interior space. Further, the swivel joint element may be coupled to the first bearing ring. Further, the mounting plate may be disposed adjacent to the tilt end. Further, the mounting plate may be rotatably coupled with the swivel joint element. Further, the mounting plate may be configured for mounting the solar panel on the mounting plate. Further, the post may include a first end and a second end. Further, the first end may be positioned opposite to the second end along the post. Further, the first end may be fixedly coupled to the first bearing ring. Further, the rotating assembly may include a motor. Further, the rotating assembly may be coupled to the post. Further, the motor may be operatively coupled with the primary bearing. Further, the plurality of secondary bearings may be attached around the tilt housing along a line parallel to the tilt edge. Further, the plurality of secondary bearings may be configured for orientably supporting the mounting plate rotatably coupled to the swivel joint element.

Further disclosed herein is an apparatus for adjustably mounting a solar panel, in accordance with some embodiments. Accordingly, the apparatus may include a tilt housing, a primary bearing, a swivel joint element, a mounting plate, a post, a rotating assembly, and a plurality of secondary bearings. Further, the tilt housing may include a tilt end and a base end. Further, the tilt end and the base end are positioned terminally opposite to each other along the tilt housing. Further, the tilt housing defines an interior space extending between the tilt end and the base end. Further, the tilt housing may be circularly cylindrical shaped. Further, the tilt housing may include a tilt edge defining the tilt end. Further, the tilt edge may be beveled. Further, the primary bearing may be disposed adjacent to the base end. Further, the primary bearing may include a first bearing ring and a second bearing ring. Further, the first bearing ring and the second bearing ring are rotatably engaged. Further, the second bearing ring may be fixedly coupled to the base end of the tilt housing. Further, the swivel joint element may be comprised in the interior space. Further, the swivel joint element may be coupled to the first bearing ring. Further, the mounting plate may be disposed adjacent to the tilt end. Further, the mounting plate may be rotatably coupled with the swivel joint element. Further, the mounting plate may be configured for mounting the solar panel on the mounting plate. Further, the post may include a first end and a second end. Further, the first end may be positioned opposite to the second end along the post. Further, the first end may be fixedly coupled to the first bearing ring. Further, the post may include at least one bracket comprised in the first end of the post. Further, the at least one bracket may be configured for attaching the tilt housing in at least one orientation in relation to the post. Further, the at least one bracket may be configured to be attached to the first bearing ring of the primary bearing for the coupling of the first end to the first bearing ring. Further, the rotating assembly may include a motor. Further, the rotating assembly may be coupled to the post. Further, the motor may be operatively coupled with the primary bearing. Further, the plurality of secondary bearings may be attached around the tilt housing along a line parallel to the tilt edge. Further, the plurality of secondary bearings may be configured for orientably supporting the mounting plate rotatably coupled to the swivel joint element.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a top perspective view of the solar panel turret apparatus.

FIG. 2 is a side view of the solar panel turret apparatus.

FIG. 3 is an exploded view of the solar panel turret apparatus.

FIG. 4 is a detailed view of the solar panel turret apparatus taken along circle A in FIG. 3

FIG. 5 is a circuit diagram used in the solar panel turret apparatus.

FIG. 6 is a side view of an apparatus 600 for adjustably mounting a solar panel 632, in accordance with some embodiments.

FIG. 7 is a partial side perspective view of the tilt housing 602 with the mounting plate 608 and the plurality of secondary bearings 614-620, in accordance with some embodiments.

FIG. 8 is a top perspective view of the tilt housing 602 with the swivel joint element 606 and the plurality of secondary bearings 614-620, in accordance with some embodiments.

FIG. 9 is a top perspective view of the tilt housing 602 with the swivel joint element 606 and the plurality of attaching elements 902-908 without the plurality of secondary bearings 614-620, in accordance with some embodiments.

FIG. 10 is a top perspective view of the tilt housing 602 with the swivel joint element 606 and the plurality of attaching elements 902-908 without the plurality of secondary bearings 614-620, in accordance with some embodiments.

FIG. 11 is a bottom perspective view of the tilt housing 602 with the primary bearing 604 and the plurality of secondary bearings 614-620, in accordance with some embodiments.

FIG. 12 is a bottom perspective view of the apparatus 600 without the swivel joint element 606 and the mounting plate 608, in accordance with some embodiments.

FIG. 13 is a side view of the apparatus 600, in accordance with some embodiments.

FIG. 14 is a side view of the apparatus 600, in accordance with some embodiments.

FIG. 15 is a bottom perspective view of the primary bearing 604 and the gear 1302, in accordance with some embodiments

FIG. 16 is a bottom perspective view of the primary bearing 604, in accordance with some embodiments.

FIG. 17 is a side view of the apparatus 600, in accordance with some embodiments.

FIG. 18 is a side view of an apparatus 1800 for adjustably mounting a solar panel 1832, in accordance with some embodiments.

FIG. 19 is a side view of an apparatus 1900 for adjustably mounting a solar panel 1932, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of systems, apparatuses, and devices for adjustably mounting a solar panel, embodiments of the present disclosure are not limited to use only in this context.

### Overview

The present disclosure describes systems, apparatuses, and devices for adjustably mounting a solar panel.

Further, the present disclosure describes a solar panel turret apparatus that features fewer moving parts compared to other conventional systems. More specifically, the solar panel turret apparatus utilizes a singular motor driven system, that enables a solar panel mounted on the turret device to rotate 360 degrees horizontally. The single motor and single rotational movement allow the turret to adjust to a wide range of angles. Further, the solar panel turret apparatus is a solely software driven apparatus, where the software is configured to manipulate the solar panel turret apparatus to achieve optimal solar capture. In other words, the precision stepper motor controlled by the software enables the solar panel turret apparatus to locate the sun anywhere in the sky with the press of a button. This solely software driven controlling means eliminates the need for sensors, thereby reducing costs while increasing the reliability of the solar panel turret apparatus. Furthermore, when used in tandem, each solar panel can position independently, or a group can position it in a way beneficial to the entire array.

The solar panel turret apparatus aims to solve problems associated with solar panel fixtures. The solar panel turret apparatus features fewer moving parts compared to any other conventional system. The solar panel turret apparatus utilizes a singular motor driven system. The solar panel turret apparatus is solely software driven, where the software is configured to manipulate the solar panel turret apparatus to achieve optimal solar capture. This solely software driven controlling means eliminates the need for sensors, therefore reducing costs while increasing the reliability of the solar panel turret apparatus.

The present disclosure relates to solar panel technologies. More specifically, the present disclosure relates to automated solar panel turret fixtures.

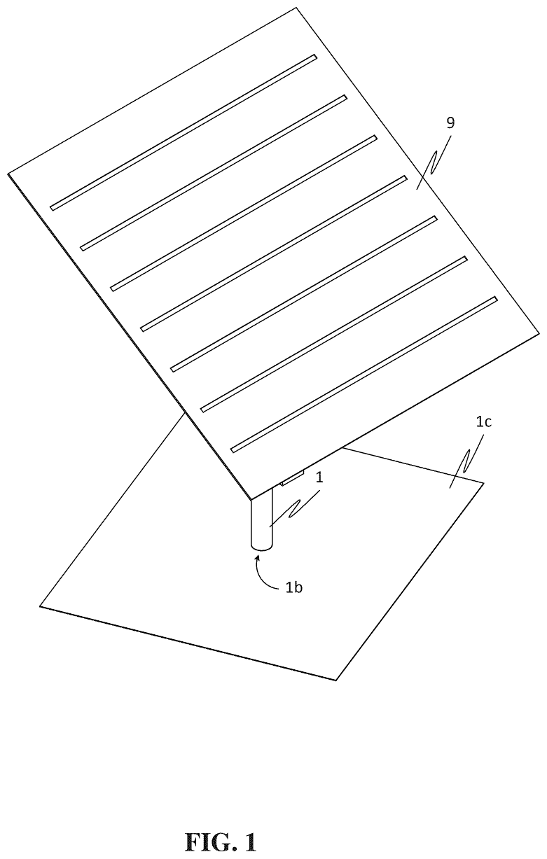

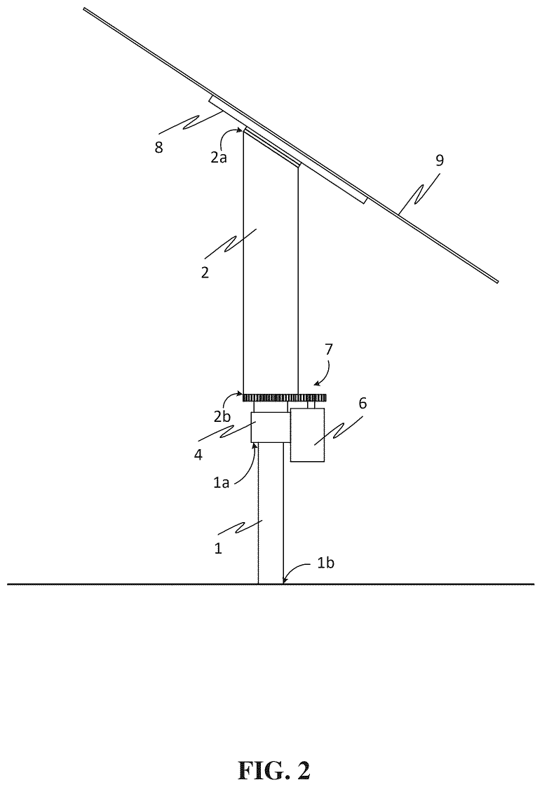

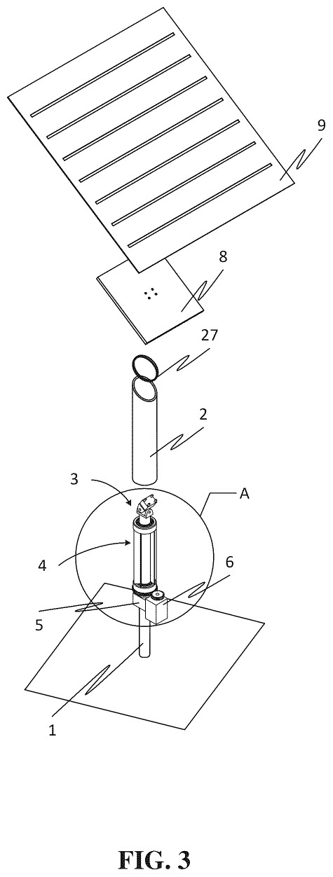

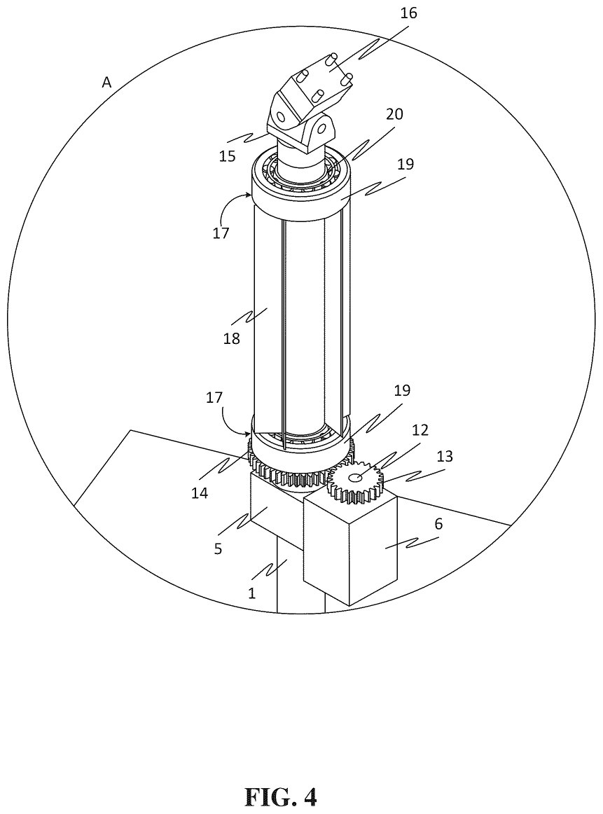

The following description is in reference to FIG. 1 through FIG. 5. According to a preferred embodiment, the solar panel turret apparatus comprises a foundation post 1, a tilt housing 2, a swivel joint element 3, a rotary assembly 4, a mounting bracket 5, a motor 6, a driving element 7, a mounting plate 8, a solar panel 9. The foundation post 1 comprises a first end 1a and a second end 1b, wherein the first end 1a is positioned opposite to the second end 1b along the foundation post 1. In the preferred embodiment, the foundation post 1 takes the form of any suitable static vertical support implement that provides structural support to the components that constitute the solar panel turret apparatus. More specifically, the foundation post 1 takes the form of a rigid pole, where the first end 1a serves as the upper end, while the second end 1b serves as the base end of the post fixed onto any flat surface (1c), platform, or any other suitable surface. The tilt housing 2 comprises a tilt end 2a and a base end 2b, wherein the tilt end 2a and the base end 2b are positioned terminally opposite to each other along the tilt housing 2. In the preferred embodiment, the tilt housing 2 serves as the main tilting member of the solar panel turret apparatus, where the tilt housing 2 is configured to tilt and swivel the mounting plate 8 along the tilt end 2a when the tilt housing 2 is rotating along the rotary assembly 4. In other words, the rotary assembly 4 is rotatably connected within the tilt housing 2. To that end, the motor 6 is connected adjacent to the mounting bracket 5, and the motor 6 is operatively engaged to the base end 2b through the driving element 7. In the preferred embodiment, the driving element 7 takes the form of any suitable driving element that mechanically bridges the operative connection of the motor 6 and the tilt base end 2b. In the preferred embodiment, the mounting bracket 5 takes the form of any suitable mounting bracket 5 that mounts the motor 6 to the foundation post 1. Additionally, the mounting bracket 5 is configured to mount the rotary assembly 4 along the mounting post, where the mounting bracket 5 is fixed along the foundation post 1, and wherein the rotary assembly 4 is connected to the mounting bracket 5. Further, the mounting bracket 5 is connected between the rotary assembly 4 and the first end 1a. As seen in FIG. 2, the rotary assembly 4 is mounted along the foundation post 1 through the mounting bracket 5, wherein the rotary assembly 4 extends away from the first end 1a opposite to the second end 1b. Further, the rotary assembly 4 is connected to the mounting bracket 5.

In the preferred embodiment, the swivel join element 3 is connected adjacent to the first end 1a. Working in conjunction with the swivel joint element 3 and the tilt end 2a, the mounting plate 8 cams along the tilt end 2a profile such that the mounting plate 8 tilts to a specified angle range. In the preferred embodiment, the tilt end 2a of the tilt housing 2 takes the form of an angled cut, such that the mounting plate 8 cams and swivels along the tilt housing 2 when the tilt housing 2 is rotating along the rotary assembly 4. This tilting articulation allows the solar panel turret apparatus to adjust to a specified angle, allowing the mounting plate 8 to orient at an optimal position suitable for solar capture. In the preferred embodiment, the mounting plate 8 facilitates the connection of the solar panel 9. To accomplish this, the mounting plate 8 is connected adjacent to the swivel joint element 3 opposite to the first end 1a, and the solar panel 9 is mounted onto the mounting plate 8. The solar panel 9 may comprise any size, material, components, arrangement of components, etc. that are known to one of ordinary skill in the art, as long as the intents of the solar panel turret apparatus are not altered.

As seen in FIG. 2, the solar panel turret apparatus comprises a rotary element 10, wherein the rotary element 10 is rotatably connected between the tilt end 2a and the mounting plate 8. In other words, the rotary element 10 acts as a sandwiching member between the mounting plate 8 and the tilt end 2a of the tilt housing 2. This is so that, the motor 6 actuates the tilt housing 2, and that the tilt housing 2 rotates along the rotary element 10, relative to the foundation post 1.

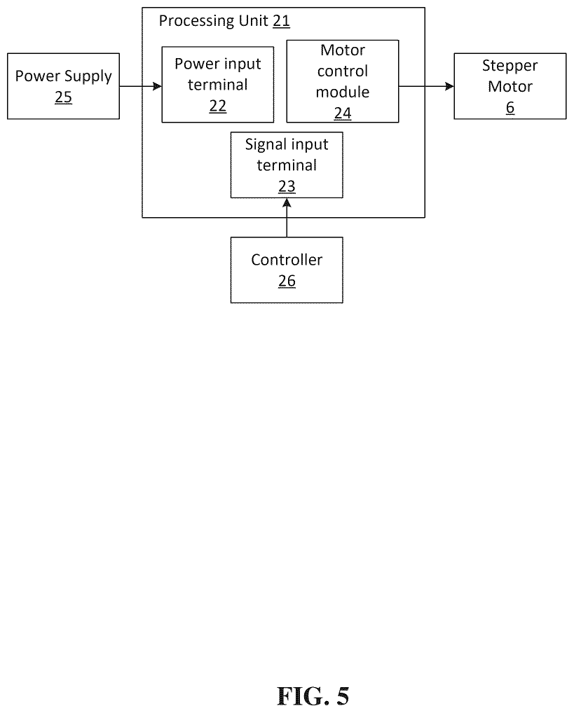

Continuing with the preferred embodiment, the motor 6 comprises a stator body 11 and a rotary shaft 12. As seen in FIG. 5, the stator body 11 is connected adjacent to the mounting bracket 5 and the rotary shaft 12 is rotatably engaged to the stator body 11. In the preferred embodiment, the motor 6 takes the form of a stepper motor. It should be noted that the motor may comprise any size, brand, technology, etc. that is known to one of ordinary skill in the art, as long as the intents of the solar panel turret apparatus are not altered.

According to the preferred embodiment, the driving element 7 comprises a drive gear 13 and a turret gear 14. Preferably, the drive gear 13 is torsionally connected to the rotary shaft 12, and the turret gear 14 is torsionally connected to the base end 2b. Furthermore, the drive gear 13 and the turret gear 14 are rotatably engaged to each other.

In the preferred embodiment, the swivel joint element 3 takes the form of any suitable articulated joint element 3 that facilitates a free range of motion while maintaining a secure connection along the first end 1a and the mounting plate 8. To accomplish this, the swivel joint element 3 comprises a first joint connector 15 and a second joint connector 16. Preferably, the first joint connector 15 and the second joint connector 16 are hingedly connected to each other. Further, the first joint connector 15 is connected adjacent to the first end 1a, and the second joint connector 16 is connected adjacent to the mounting plate 8.

In the preferred embodiment, the rotary assembly 4 comprises a plurality of roller elements 17 and a plurality of vertical supports 18. Preferably, the plurality of roller elements 17 are distributed along the foundation post 1, and the plurality of vertical supports 18 are distributed about the plurality of roller elements 17. Further, the plurality of vertical supports 18 traverses along the plurality of roller elements 17. Additionally, each of the plurality of roller elements 17 comprises a mounting ring 19 and a rotary ring 20. Preferably, the rotary ring 20 is rotatably connected to the mounting ring 19, and the mounting ring 19 is torsionally connected to the tilt housing 2. In the preferred embodiment, the plurality of roller elements 17 takes the form of roller bearings that installs between the foundation post 1 and the tilt housing 2, wherein the rotary ring 20 is situated along the foundation post 1 and the mounting ring 19 is situated along the interior of the tilt housing 2. In the preferred embodiment, the plurality of vertical supports 18 takes the form of any suitable vertical supporting implement, such as, but not limited to L-beam extrusions or any other suitable vertical supporting implement. Thus, the plurality of vertical supports 18 bridges the plurality of roller elements 17 together to form the rotary assembly 4. Additionally, the plurality of vertical supports 18 serves as additional structural integrity along the tilt housing 2.

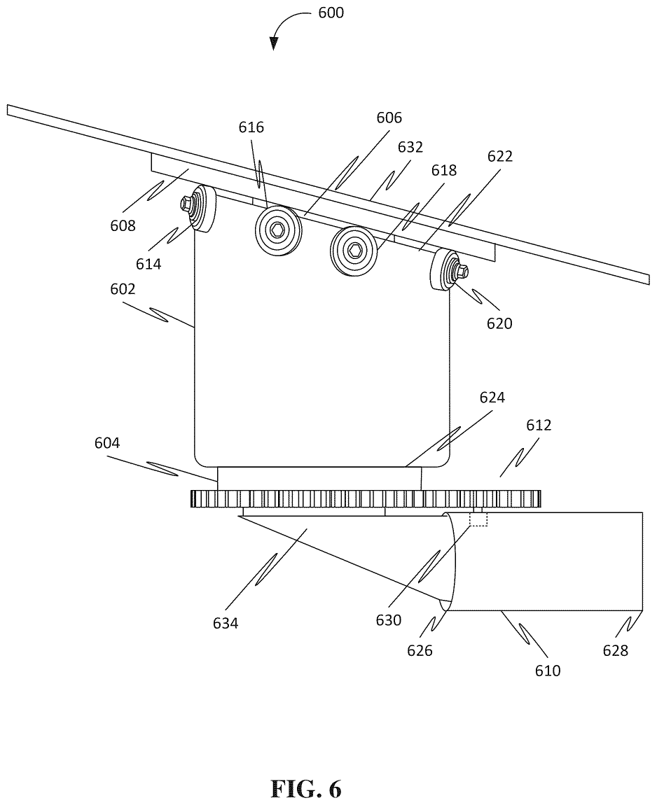

Continuing with the preferred embodiment, and in reference to FIG. 6, the solar panel turret apparatus comprises a processing unit 21, wherein the processing unit 21 is electronically connected to the motor 6. In the preferred embodiment, the processing unit 6 serves as the on-board PCB that handles all electronic and electrical functions associated with the solar panel turret apparatus. Preferably, the processing unit 21 comprises a power input terminal 22, a signal input terminal 23, and a motor control module 24. As seen in FIG. 6, the solar panel turret apparatus further comprises a power supply 25 and a controller 26. In the preferred embodiment, the power supply 25 is electrically connected to the power input terminal 22. Preferably, the power supply 25 takes the form of any suitable power supply, such as, but not limited to direct feed solar panel feed power bank, external power source, or any other suitable power supply. In the preferred embodiment, the controller 26 takes the form of any suitable interface module that transmits software driven motor commands to the processing unit 21, such that the processing unit 21 interacts with the motor control module 24, where the motor control module 24 manipulates the motor 6, and where the motor 6 is configured to rotate the tilt housing 2 which in turn will tilt the mounting plate 8 to any position along the tilt housing 2. To accomplish this, the power supply 25 is electrically connected to the power input terminal 22, the controller 26 is electronically connected to the signal input terminal 23, and the motor control module 24 is electronically connected to the motor 6. It should be noted that any other mechanical (for example thrust bearing 27), electrical and electronic components that are known to one of ordinary skill in the art may be utilized by the solar panel turret apparatus, as long as the intents of the solar panel turret apparatus are not altered. More specifically, the solar panel turret apparatus may be linked to tracking systems that utilize a specific circuit board and firmware/software to track the target (sun), by reading the valve via a power collection sensor. Solar panel array power collection value is interpreted by the firmware and in return will control the single motor to find the highest power collection value and follow the source. East and west (horizontal control) has a 360-degree range. North and south (vertical) control has a range between 15-45 degrees. Systems can be linked together to control multiple tracking units or independently. Controlling data/parameters and recorded data can be accessed via circuit board mounted screen and or Bluetooth, Wi-Fi connection. Thus, when used in tandem, each solar panel can be positioned independently, or a group can position it in a way beneficial to the entire array.

FIG. 6 is a side view of an apparatus 600 for adjustably mounting a solar panel 632, in accordance with some embodiments. Accordingly, the apparatus 600 may include a tilt housing 602, a primary bearing 604, a swivel joint element 606, a mounting plate 608, a post 610, a rotating assembly 612, and a plurality of secondary bearings 614-620. Further, the apparatus 600 may include a solar panel turret apparatus, a solar panel turret device, etc.

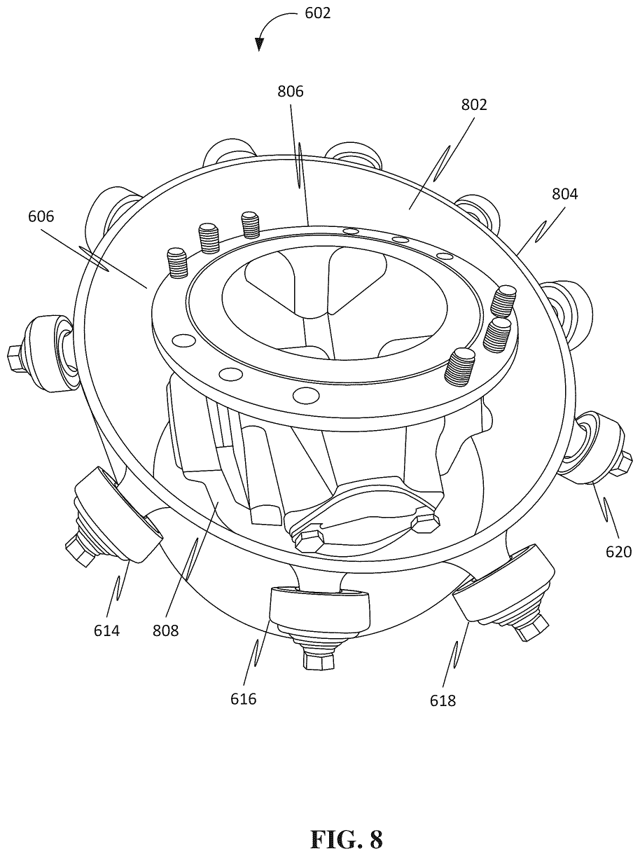

Further, the tilt housing 602 may include a tilt end 622 and a base end 624. Further, the tilt end 622 and the base end 624 are positioned terminally opposite to each other along the tilt housing 602. Further, the tilt housing 602 defines an interior space 802, as shown in FIG. 8, extending between the tilt end 622 and the base end 624. Further, the tilt housing 602 may include a tilt edge 804, as shown in FIG. 8, defining the tilt end 622. Further, the tilt edge 804 may be beveled. Further, in an embodiment, the tilt housing 602 may include a tilt opening at the tilt end 622. Further, the tilt edge 804 defines the tilt opening. Further, the tilt housing 602 may include a base opening at the base end 624. Further, the tilt edge 804 may be elliptically shaped. Further, the tilt edge 804 may be defined by an oblique cut relative to a longitudinal axis of the tilt housing 602 for forming an elliptical periphery. Further, the tilt edge forms a bevel angle relative to the longitudinal axis. Further, the bevel angle may range between 5 degrees and 60 degrees. Further, the bevel angle may range between 1 degree and 75 degrees. Further, the bevel angle may range between 1 degree and 30 degrees.

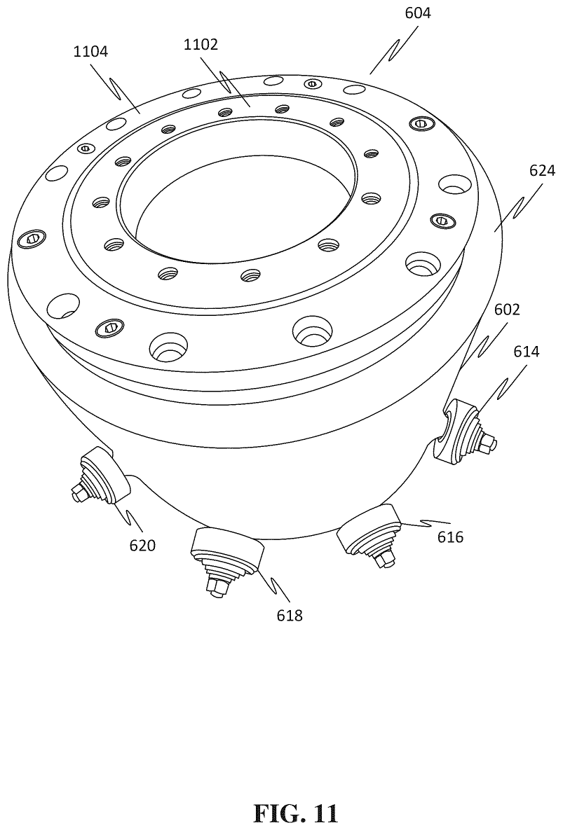

Further, the primary bearing 604 may be disposed adjacent to the base end 624. Further, the primary bearing 604 may include a first bearing ring 1102 and a second bearing ring 1104, as shown in FIG. 11. Further, the first bearing ring 1102 and the second bearing ring 1104 are rotatably engaged. Further, the second bearing ring 1104 may be fixedly coupled to the base end 624 of the tilt housing 602. Further, the primary bearing 604 may at least one of radially and axially supporting the tilt housing 602. Further, the coupling of the second bearing ring 1104 to the base end 624 may include torsionally connecting, mechanically connecting, etc. Further, the primary bearing 604 may include a slewing bearing, a slew ring bearing, a turntable bearing, etc. Further, the primary bearing 604 may include a three row roller bearing. Further, in an embodiment, the primary bearing 604 may be configured as a slewing bearing with two or more rows of rolling elements between the first bearing ring 1102 and the second bearing ring 1104. Further, in an embodiment, the second bearing ring 1104 and the first bearing ring 1102 may be concentric around a central axis. Further, the primary bearing 604 may include a plurality of rows of rolling elements disposed between the first bearing ring 1102 and the second bearing ring 1104. Further, the rotatably engaging of the first bearing ring 1102 and the second bearing ring 1104 may be based on the plurality of rows of the rolling elements. Further, the plurality of rows of the rolling elements may include at least one first row of rolling elements and at least one second row of rolling elements. Further, the at least one first row of the rolling elements transmits axial force parallel to the central axis between the first bearing ring 1102 and the second bearing ring 1104. Further, the at least one second row of the rolling elements transmits radial force perpendicular to the central axis between the first bearing ring 1102 and the second bearing ring 1104. Further, the rolling elements may include rollers, balls, cylinders, etc. Further, in an embodiment, the first bearing ring 1102 may include an inner ring, an inner race, etc. Further, the second bearing ring 1104 may include an outer ring, an outer race, etc. Further, in an embodiment, the primary bearing 604 may include a first bearing face, a second bearing face, and a primary hole extending therebetween. Further, the first bearing face may be positioned to face toward the base end 624. Further, at least a portion of at least one of the primary bearing 604 and the first bearing ring 1102 extends from the base opening.

Further, the swivel joint element 606 may be comprised in the interior space 802. Further, the swivel joint element 606 may be coupled to the first bearing ring 1102. Further, the swivel joint element 606 may be coupled to the first bearing ring 1102 from a first side of the primary bearing 604. Further, the swivel joint element 606 may include a hinge joint, a universal joint, a ball and socket joint, etc. Further, the first bearing face may be positioned to face toward the swivel joint element 606. Further, the swivel joint element 606 may allow a plurality of rotational movement along a plurality of axes of the swivel joint element 606. Further, at least a portion of the swivel joint element 606 may extend from the tilt opening. Further, at least a portion of the swivel joint element 606 may extend beyond the tilt edge 804 through the tilt opening.

Further, the mounting plate 608 may be disposed adjacent to the tilt end 622. Further, the mounting plate 608 may be rotatably coupled with the swivel joint element 606. Further, the mounting plate 608 may be configured for mounting the solar panel 632 on the mounting plate 608. Further, the mounting plate 608 may include a top surface and a bottom surface opposing the top surface. Further, the bottom surface faces toward the tilt end 622. Further, the coupling of the mounting plate 608 with the swivel joint element 606 may include attaching, securing, affixing, etc. the mounting plate 608 with the swivel joint element 606. Further, the mounting of the solar panel 632 on the mounting plate 608 may include at least one of attaching, securing, and affixing the solar panel on the top surface of the mounting plate 608.

Further, the post 610 may include a first end 626 and a second end 628. Further, the first end 626 may be positioned opposite to the second end 628 along the post 610. Further, the first end 626 may be fixedly coupled to the first bearing ring 1102. Further, the first end 626 may be fixedly coupled to the first bearing ring 1102 from a second side opposite to the first side of the first bearing ring 1102. Further, the post 610 may include a foundation post. Further, the second bearing face may face toward the first end 626. Further, the second end 628 may be configured to be attached to at least one of an external structure and an external surface for affixing the post 610 to at least one of the external structure and the external surface.

Further, the rotating assembly 612 may include a motor 630. Further, the rotating assembly 612 may be coupled to the post 610. Further, the motor 630 may be operatively coupled with the primary bearing 604. Further, the rotating assembly 612 may be configured for rotating the tilt housing 602 about a central housing axis. Further, the rotating of the tilt housing 602 transitions the mounting plate 608 in a plurality of orientations in relation to a reference horizontal plane of the mounting plate 608. Further, the plurality of orientations corresponds to a plurality of horizontal planes of the mounting plate 608. Further, each of the plurality of horizontal planes may be parallel to the mounting plate 608 after transitioning the mouting plate 608 in each of the plurality of orientations respectively.

Further, the plurality of secondary bearings 614-620 may be attached around the tilt housing 602 along a line parallel to the tilt edge 804. Further, the plurality of secondary bearings 614-620 may be configured for orientably supporting the mounting plate 608 rotatably coupled to the swivel joint element 606. Further, the plurality of secondary bearings 614-620 may include a ball bearing, a thrust bearing, a roller bearing, a tapered roller bearing, etc. Further, in an embodiment, each of the plurality of secondary bearings 614-620 may include a first bearing face, a second bearing face opposite to the first bearing face, and a secondary hole extending therebetween. Further, the first bearing face of each of the plurality of secondary bearings 614-620 may face towards an exterior surface of the tilt housing 602.

Further, in some embodiments, the tilt housing 602 may be circularly cylindrical shaped. Further, the tilt housing 602 may include a base wall and a side wall peripherally extending from the base wall. Further, the base wall may be circularly shaped. Further, the side wall may be cylindrically shaped. Further, the base wall may include the base opening. Further, the base wall extends from the base end 624 to the tilt end 622. Further, the side wall may include a free edge at the tilt end 622 defining the tilt edge 804.

Further, in an embodiment, at least one of the plurality of secondary bearings 614-620 may be attached at least one of interiorly and exteriorly around the tilt housing 602 along the line parallel to the tilt edge 804. Further, the line may be an imaginary line. Further, the plurality of secondary bearings 614-620 may be evenly spaced around the tilt housing 602.

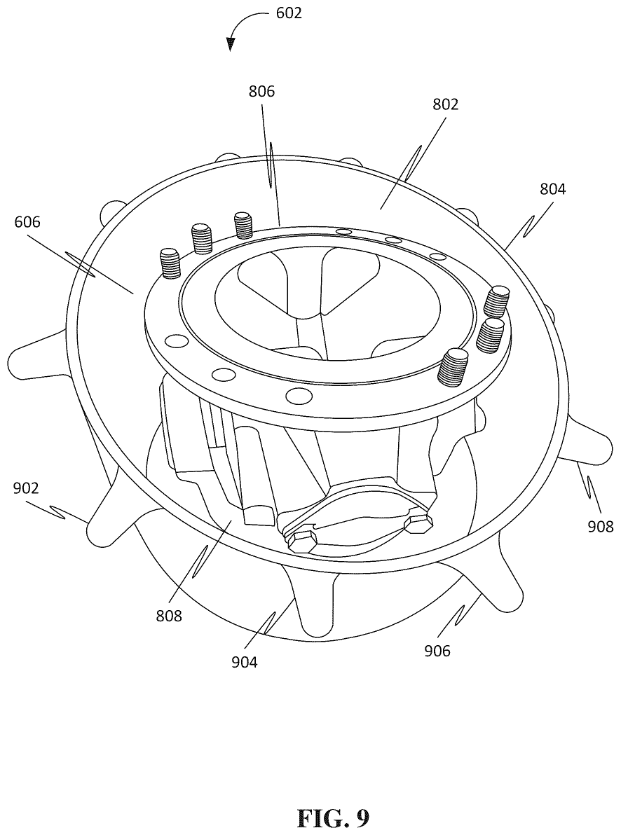

Further, in an embodiment, the tilt housing 602 may include a plurality of attaching elements 902-908, as shown in FIG. 9, disposed at least one of interiorly and exteriorly around the tilt housing 602 along the line parallel to the tilt edge 804. Further, each of the plurality of attaching elements 902-908 radially extends from the tilt housing 602. Further, each of the plurality of secondary bearings 614-620 may be attached to each of the plurality of attaching elements 902-908 respectively. Further, the attaching of the plurality of bearings around the tilt housing 602 may be based on the attaching of each of the plurality of secondary bearings 614-620 to each of the plurality of attaching elements 902-908 respectively. Further, each of the plurality of secondary bearings 614-620 receives each of the plurality of attaching elements 902-908 respectively in the secondary hole of each of the plurality of attaching elements 902-908.

Further, in an embodiment, at least one of the plurality of attaching elements 902-908 may be inclined upward at a non-zero angle relative to a horizontal plane of the tilt housing 602. Further, the non-zero angle ranges between 1 degree and 30 degrees. Further, the non-zero angle ranged between 5 degrees and 10 degrees.

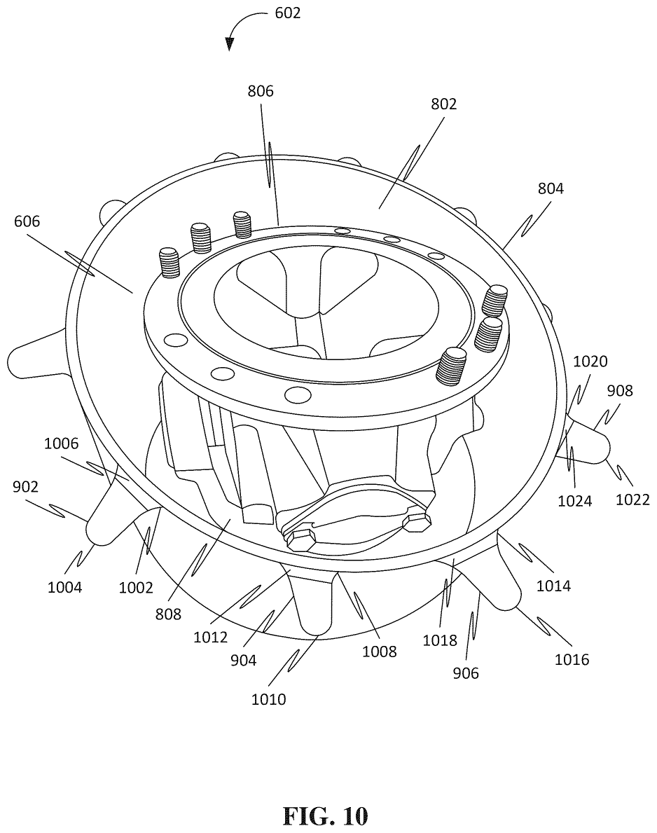

Further, in an embodiment, each of the plurality of attaching elements 902-908 extends between a proximal end (1002, 1008, 1014, and 1020) and a distal end (1004, 1010, 1016, and 1022), as shown in FIG. 10. Further, each of the plurality of attaching elements 902-908 may include an elasticity element (1006, 1012, 1018, and 1024), as shown as 10, comprised in the proximal end (1002, 1008, 1014, and 1020). Further, the proximal end (1002, 1008, 1014, and 1020) of each of the plurality of attaching elements 902-908 may be attached to the tilt housing 602. Further, the elasticity element (1006, 1012, 1018, and 1024) may be comprised of at least one material. Further, the at least one material may be elastically stretchable, etc. Further, the at least one material may include rubber, neoprene, etc. Further, the elasticity element (1006, 1012, 1018, and 1024) may include a spring.

Further, in an embodiment, at least one of the plurality of attaching elements 902-908 may be configured to be transitioned between a plurality of positions based on the elasticity element. Further, each of the plurality of positions corresponds to an angle ranging between the non-zero angle and a zero angle of at least one of the plurality of attaching elements 902-908 relative to the horizontal plane. Further, the non-zero angle ranges between 5 degrees and 30 degrees. Further, the non-zero angle ranges between 1 degree and 5 degrees. Further, the non-zero angle ranges between 30 degrees and 75 degrees.

Further, in an embodiment, at least a portion of each of the plurality of secondary bearings 614-620 extends beyond the tilt edge 804 based on the attaching of each of the plurality of secondary bearings 614-620 to each of the plurality of attaching elements 902-908 respectively.

Further, in an embodiment, each of the plurality of secondary bearings 614-620 radially supports the mounting plate 608 on each of the plurality of secondary bearings 614-620. Further, each of the plurality of secondary bearings 614-620 may include an inner ring, an outer ring, and one or more rows of rolling elements disposed between the outer ring and the inner ring. Further, the inner ring and the outer ring may be be concentric around a central axis of each of the plurality of secondary bearings 614-620. Further, the inner ring and the outer ring may be rotatably enagaged. Further, the radially supporting by each of the plurality of secondary bearing 614-620 may include radially supporting the mounting plate 608 on the outer ring. Further, the rotating of the tilt housing 602 rotates the outer ring in relation to the inner ring about the central axis of each of the plurality of secondary bearings 614-620. Further, the rotating of the outer ring in relation to the inner ring about the central axis of each of the plurality of secondary bearings 614-620 transitions the mounting plate 608 in the plurality of orientations in relation to the reference horizontal plane of the mounting plate 608.

Further, in an embodiment, the mounting plate 608 may be spaced from the tilt edge by a distance from the tilt edge 804. Further, the distance may be a uniform distance along the tilt edge 804. Further, the distance may be a non uniform distance along the tilt edge 804.

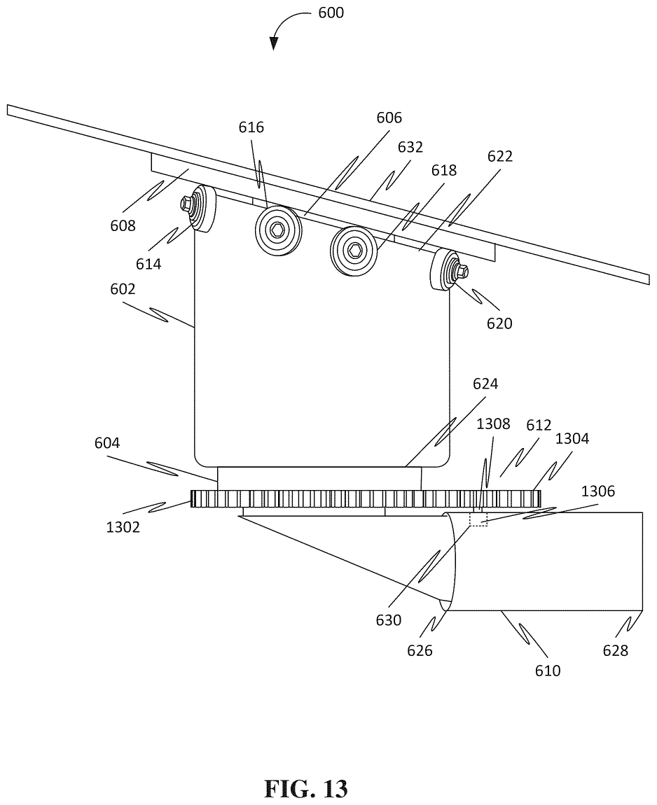

Further, in some embodiments, the rotating assembly 612 may include a gear 1302 and a drive gear 1304, as shown in FIG. 13. Further, the motor 630 may include a stator body 1306 and a rotary shaft 1308, as shown in FIG. 13, rotatably engaged with the stator body 1306. Further, the gear 1302 may be coupled to the second bearing ring 1104. Further, the drive gear 1304 may be torsionally connected to the rotary shaft 1308. Further, the gear 1302 and the drive gear 1304 are rotatably engaged.

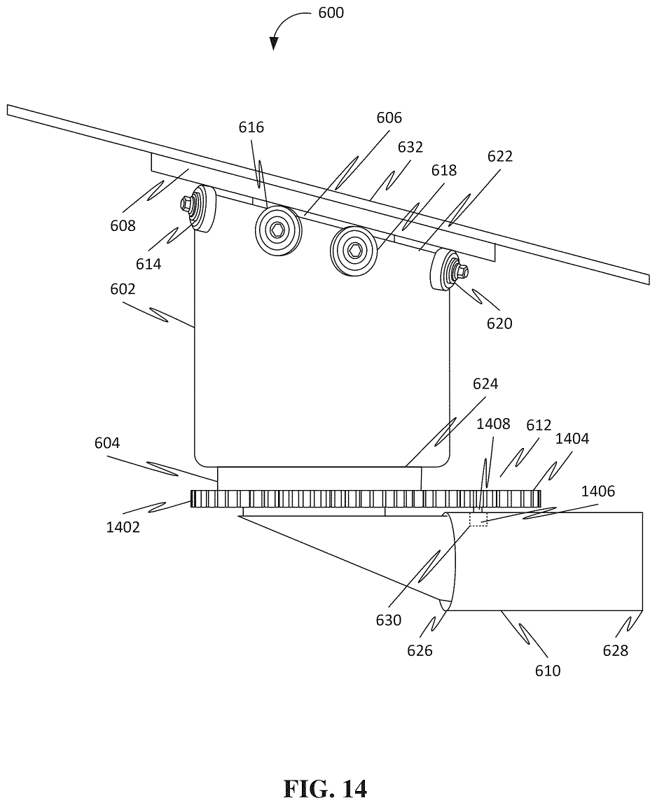

Further, in some embodiments, the second bearing ring 1104 may include a plurality of gear teeth 1402, as shown in FIG. 14, exteriorly around the second bearing ring 1104. Further, the rotating assembly 612 may include a drive gear 1404, as shown in FIG. 14. Further, the motor 630 may include a stator body 1406 and a rotary shaft 1408, as shown in FIG. 14, rotatably engaged with the stator body 1406. Further, the drive gear 1404 may be torsionally connected to the rotary shaft 1408. Further, the second bearing ring 1104 and the drive gear 1404 are rotatably engaged.

Further, in some embodiments, the swivel joint element 606 may include a first joint connector 806 and a second joint connector 808, as shown in FIG. 8. Further, the first joint connector 806 and the second joint connector 808 are rotatably connected to each other. Further, the first joint connector 806 may be fixedly coupled with the mounting plate 608. Further, the second joint connector 808 may be fixedly coupled to the first bearing ring 1102. Further, the first joint connector 806 may rotate around a plurality of axes of the first joint connector 806 in relation to the second joint connector 808. Further, the second joint connector 808 remains stationary in relation to the first joint connector 806. Further, in an embodiment, the first connector 806 may include a mounting surface and a plurality of protrusions extending from the mounting surface. Further, the mounting plate 608 may include a plurality of holes. Further, at least one of a protrusion number and a protrusion arrangement of the plurality of protrusions corresponds to at least one of a hole number and a hole arrangement of the plurality of holes. Further, each of the plurality of protrusions may be received in each of the plurality of holes respectively for the coupling of the first joint connector 806 to the mounting plate 608. Further, the protrusion number and the hole number may be 6.

Further, in some embodiments, the post 610 may include at least one bracket 634 comprised in the first end 626 of the post 610. Further, the at least one bracket 634 may be configured for attaching the tilt housing 602 in at least one orientation in relation to the post 610. Further, the at least one bracket 634 may be configured to be attached to the first bearing ring 1102 of the primary bearing 604 for the coupling of the first end 626 to the first bearing ring 1102. Further, a central housing axis of the tilt housing 602 may be perpendicular to a central post housing of the post 610 in the at least one orientation. Further, the central housing axis of the tilt housing 602 may be substantially perpendicular to the central post housing of the post 610 in the at least one orientation.

In further embodiments, the apparatus 600 may include a processing unit 1702 electronically coupled with the motor 630.

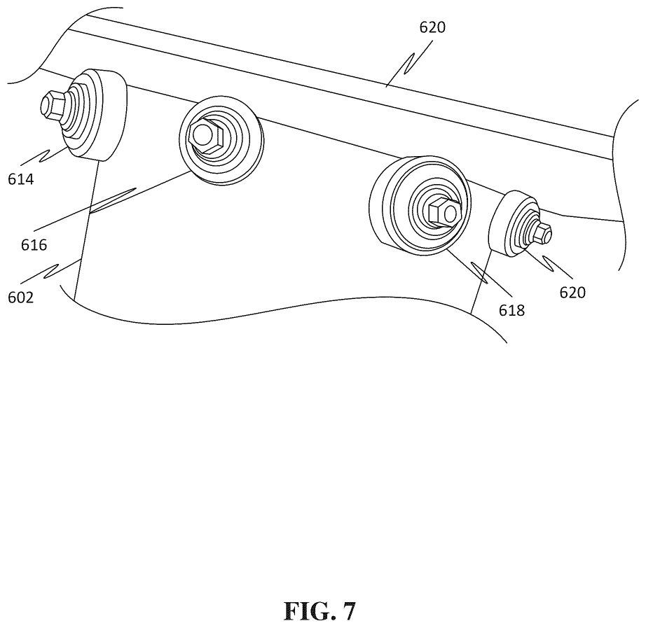

FIG. 7 is a partial side perspective view of the tilt housing 602 with the mounting plate 608 and the plurality of secondary bearings 614-620, in accordance with some embodiments.

FIG. 8 is a top perspective view of the tilt housing 602 with the swivel joint element 606 and the plurality of secondary bearings 614-620, in accordance with some embodiments.

FIG. 9 is a top perspective view of the tilt housing 602 with the swivel joint element 606 and the plurality of attaching elements 902-908 without the plurality of secondary bearings 614-620, in accordance with some embodiments.

FIG. 10 is a top perspective view of the tilt housing 602 with the swivel joint element 606 and the plurality of attaching elements 902-908 without the plurality of secondary bearings 614-620, in accordance with some embodiments.

FIG. 11 is a bottom perspective view of the tilt housing 602 with the primary bearing 604 and the plurality of secondary bearings 614-620, in accordance with some embodiments.

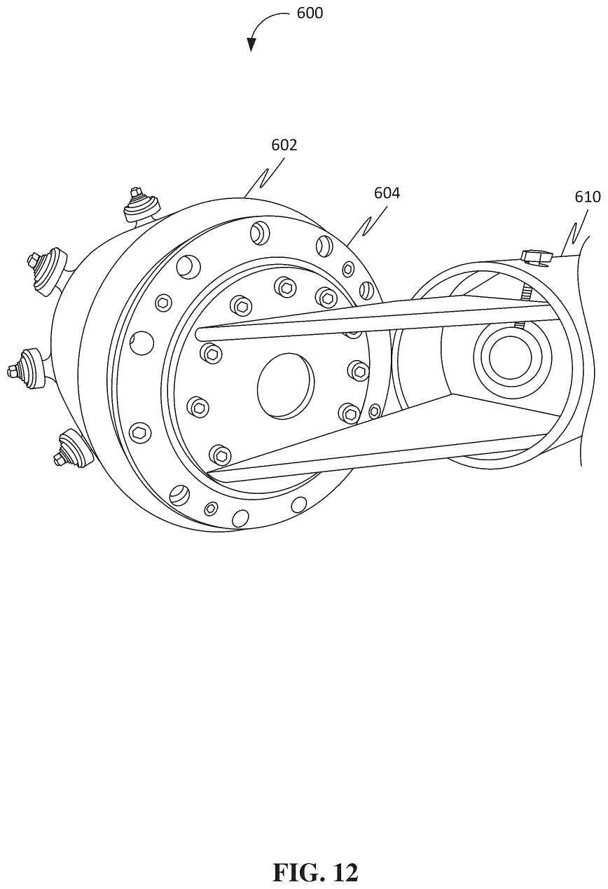

FIG. 12 is a bottom perspective view of the apparatus 600 without the swivel joint element 606 and the mounting plate 608, in accordance with some embodiments.

FIG. 13 is a side view of the apparatus 600, in accordance with some embodiments.

FIG. 14 is a side view of the apparatus 600, in accordance with some embodiments.

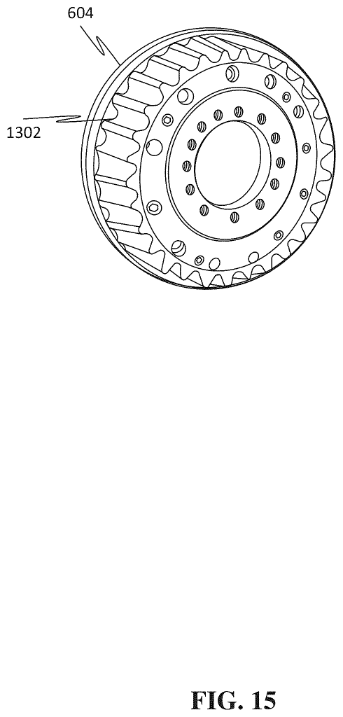

FIG. 15 is a bottom perspective view of the primary bearing 604 and the gear 1302, in accordance with some embodiments

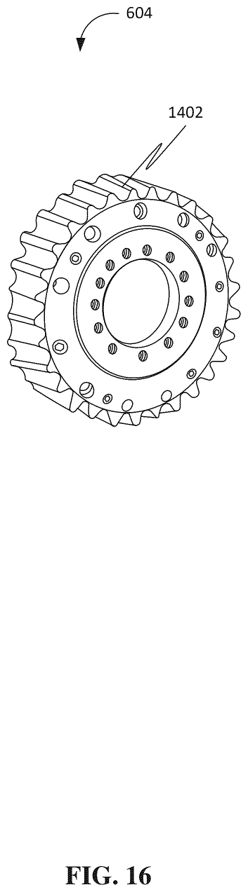

FIG. 16 is a bottom perspective view of the primary bearing 604, in accordance with some embodiments.

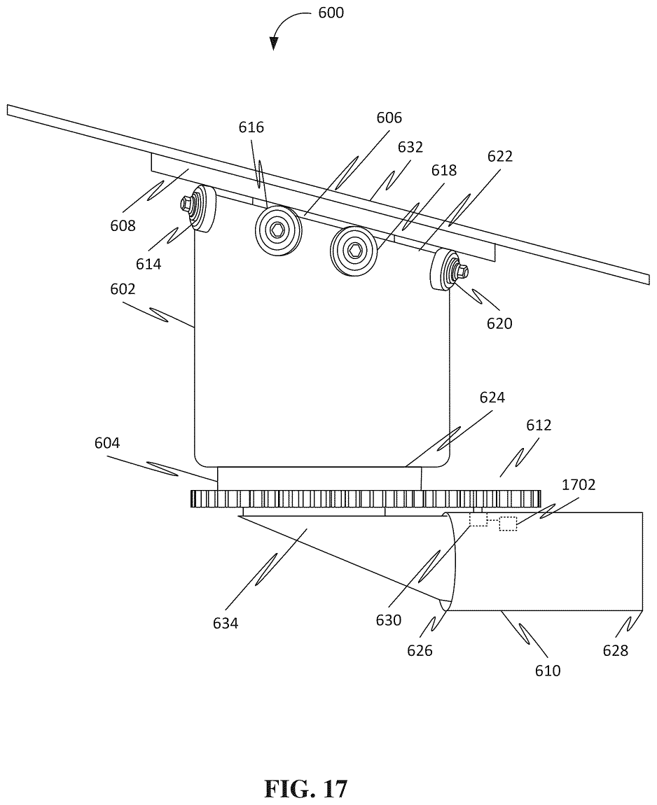

FIG. 17 is a side view of the apparatus 600, in accordance with some embodiments.

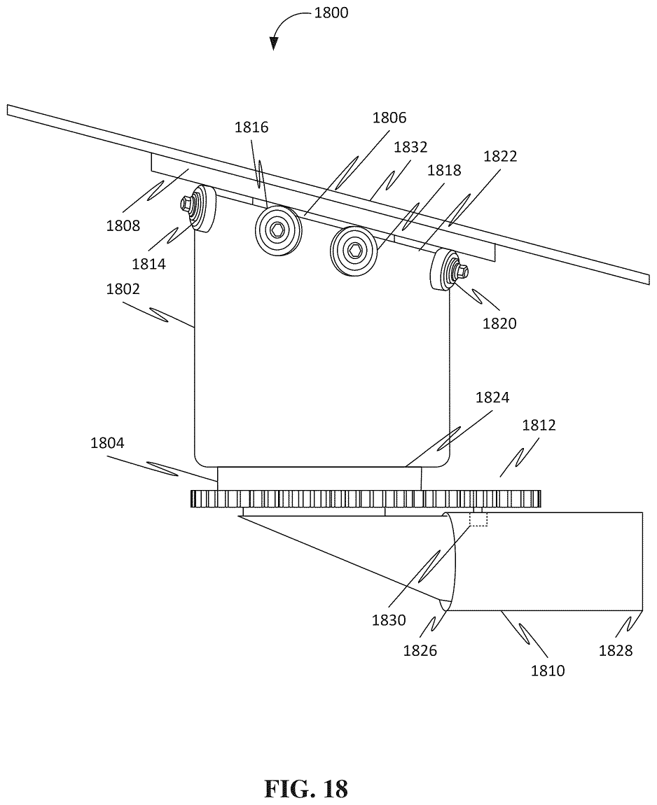

FIG. 18 is a side view of an apparatus 1800 for adjustably mounting a solar panel 1832, in accordance with some embodiments. Accordingly, the apparatus 1800 may include a tilt housing 1802, a primary bearing 1804, a swivel joint element 1806, a mounting plate 1808, a post 1810, a rotating assembly 1812, and a plurality of secondary bearings 1814-1820.

Further, the tilt housing 1802 may include a tilt end 1822 and a base end 1824. Further, the tilt end 1822 and the base end 1824 are positioned terminally opposite to each other along the tilt housing 1802. Further, the tilt housing 1802 defines an interior space extending between the tilt end 1822 and the base end 1824. Further, the tilt housing 1802 may be circularly cylindrical shaped. Further, the tilt housing 1802 may include a tilt edge defining the tilt end 1822. Further, the tilt edge may be beveled.

Further, the primary bearing 1804 may be disposed adjacent to the base end 1824. Further, the primary bearing 1804 may include a first bearing ring and a second bearing ring. Further, the first bearing ring and the second bearing ring are rotatably engaged. Further, the second bearing ring may be fixedly coupled to the base end 1824 of the tilt housing 1802.

Further, the swivel joint element 1806 may be comprised in the interior space. Further, the swivel joint element 1806 may be coupled to the first bearing ring.

Further, the mounting plate 1808 may be disposed adjacent to the tilt end 1822. Further, the mounting plate 1808 may be rotatably coupled with the swivel joint element 1806. Further, the mounting plate 1808 may be configured for mounting the solar panel 1832 on the mounting plate 1808.

Further, the post 1810 may include a first end 1826 and a second end 1828. Further, the first end 1826 may be positioned opposite to the second end 1828 along the post 1810. Further, the first end 1826 may be fixedly coupled to the first bearing ring.

Further, the rotating assembly 1812 may include a motor 1830. Further, the rotating assembly 1812 may be coupled to the post 1810. Further, the motor 1830 may be operatively coupled with the primary bearing 1804.

Further, the plurality of secondary bearings 1814-1820 may be attached around the tilt housing 1802 along a line parallel to the tilt edge. Further, the plurality of secondary bearings 1814-1820 may be configured for orientably supporting the mounting plate 1808 rotatably coupled to the swivel joint element 1806.

Further, in some embodiments, the rotating assembly 1812 may include a gear and a drive gear. Further, the motor 1830 may include a stator body and a rotary shaft rotatably engaged with the stator body. Further, the gear may be coupled to the second bearing ring.

Further, the drive gear may be torsionally connected to the rotary shaft. Further, the gear and the drive gear are rotatably engaged.

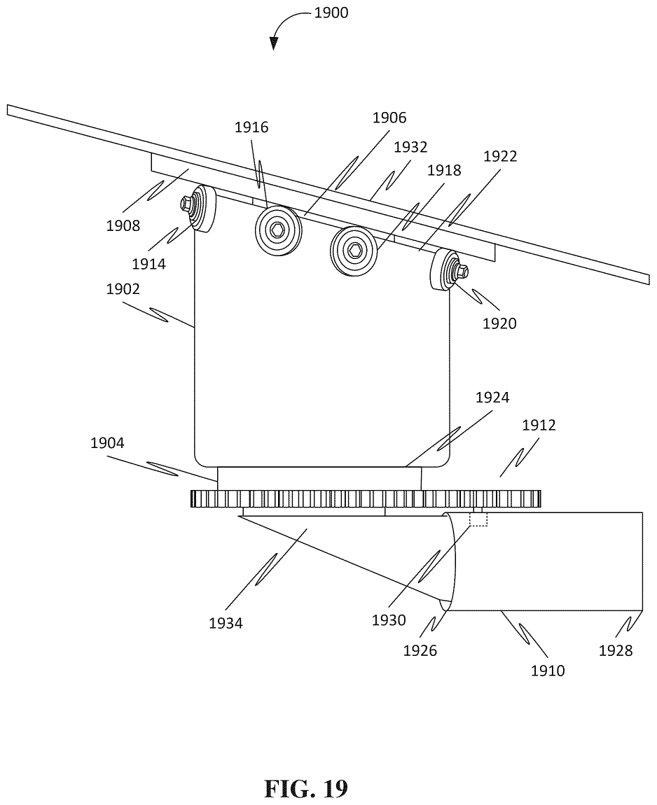

FIG. 19 is a side view of an apparatus 1900 for adjustably mounting a solar panel 1932, in accordance with some embodiments. Accordingly, the apparatus 1900 may include a tilt housing 1902, a primary bearing 1904, a swivel joint element 1906, a mounting plate 1908, a post 1910, a rotating assembly 1912, and a plurality of secondary bearings 1914-1920.

Further, the tilt housing 1902 may include a tilt end 1922 and a base end 1924. Further, the tilt end 1922 and the base end 1924 are positioned terminally opposite to each other along the tilt housing 1902. Further, the tilt housing 1902 defines an interior space extending between the tilt end 1922 and the base end 1924. Further, the tilt housing 1902 may be circularly cylindrical shaped. Further, the tilt housing 1902 may include a tilt edge defining the tilt end 1922. Further, the tilt edge may be beveled.

Further, the primary bearing 1904 may be disposed adjacent to the base end 1924. Further, the primary bearing 1904 may include a first bearing ring and a second bearing ring. Further, the first bearing ring and the second bearing ring are rotatably engaged. Further, the second bearing ring may be fixedly coupled to the base end 1924 of the tilt housing 1902.

Further, the swivel joint element 1906 may be comprised in the interior space. Further, the swivel joint element 1906 may be coupled to the first bearing ring.

Further, the mounting plate 1908 may be disposed adjacent to the tilt end 1922. Further, the mounting plate 1908 may be rotatably coupled with the swivel joint element 1906. Further, the mounting plate 1908 may be configured for mounting the solar panel 1932 on the mounting plate 1908.

Further, the post 1910 may include a first end 1926 and a second end 1928. Further, the first end 1926 may be positioned opposite to the second end 1928 along the post 1910. Further, the first end 1926 may be fixedly coupled to the first bearing ring. Further, the post 1910 may include at least one bracket 1934 comprised in the first end 1926 of the post 1910. Further, the at least one bracket 1934 may be configured for attaching the tilt housing 1902 in at least one orientation in relation to the post 1910. Further, the at least one bracket 1934 may be configured to be attached to the first bearing ring of the primary bearing 1904 for the coupling of the first end 1926 to the first bearing ring.

Further, the rotating assembly 1912 may include a motor 1930. Further, the rotating assembly 1912 may be coupled to the post 1910. Further, the motor 1930 may be operatively coupled with the primary bearing 1904.

Further, the plurality of secondary bearings 1914-1920 may be attached around the tilt housing 1902 along a line parallel to the tilt edge. Further, the plurality of secondary bearings 1914-1920 may be configured for orientably supporting the mounting plate 1908 rotatably coupled to the swivel joint element 1906.

Although the present disclosure has been explained in relation to its preferred embodiment, it is to be understood that many other possible modifications and variations can be made without departing from the spirit and scope of the disclosure.

What is claimed is:

1. An apparatus for adjustably mounting a solar panel, the apparatus comprising:
a tilt housing comprising a tilt end and a base end, wherein the tilt end and the base end are positioned terminally opposite to each other along the tilt housing, wherein the tilt housing defines an interior space extending between the tilt end and the base end, wherein the tilt housing comprises a tilt edge defining the tilt end, wherein the tilt edge is beveled. ;
a primary bearing disposed adjacent to the base end, wherein the primary bearing comprises a first bearing ring and a second bearing ring, wherein the first bearing ring and the second bearing ring are rotatably engaged, wherein the second bearing ring is fixedly coupled to the base end of the tilt housing;
a swivel joint element comprised in the interior space, wherein the swivel joint element is coupled to the first bearing ring;
a mounting plate disposed adjacent to the tilt end, wherein the mounting plate is rotatably coupled with the swivel joint element, wherein the mounting plate is configured for mounting the solar panel on the mounting plate;
a post comprising a first end and a second end, wherein the first end is positioned opposite to the second end along the post, wherein the first end is fixedly coupled to the first bearing ring;
a rotating assembly comprising a motor, wherein the rotating assembly is coupled to the post, wherein the motor is operatively coupled with the primary bearing; and
a plurality of secondary bearings attached around the tilt housing along a line parallel to the tilt edge, wherein the plurality of secondary bearings is configured for orientably supporting the mounting plate rotatably coupled to the swivel joint element.

2. The apparatus of claim 1, wherein the post comprises at least one bracket comprised in the first end of the post, wherein the at least one bracket is configured for attaching the tilt housing in at least one orientation in relation to the post, wherein the at least one bracket is configured to be attached to the first bearing ring of the primary bearing for the coupling of the first end to the first bearing ring.

3. The apparatus of claim 1, wherein the tilt housing is circularly cylindrical shaped.

4. The apparatus of claim 1, wherein at least one of the plurality of secondary bearings is attached at least one of interiorly and exteriorly around the tilt housing along the line parallel to the tilt edge.

5. The apparatus of claim 4, wherein the tilt housing further comprises a plurality of attaching elements disposed at least one of interiorly and exteriorly around the tilt housing along the line parallel to the tilt edge, wherein each of the plurality of attaching elements radially extends from the tilt housing, wherein each of the plurality of secondary bearings is attached to each of the plurality of attaching elements respectively, wherein the attaching of the plurality of bearings around the tilt housing is based on the attaching of each of the plurality of secondary bearings to each of the plurality of attaching elements respectively.

6. The apparatus of claim 5, wherein at least one of the plurality of attaching elements is inclined upward at a non-zero angle relative to a horizontal plane of the tilt housing.

7. The apparatus of claim 6, wherein each of the plurality of attaching elements extends between a proximal end and a distal end, wherein each of the plurality of attaching elements comprises an elasticity element comprised in the proximal end, wherein the proximal end of each of the plurality of attaching elements is attached to the tilt housing.

8. The apparatus of claim 7, wherein at least one of the plurality of attaching elements is configured to be transitioned between a plurality of positions based on the elasticity element, wherein each of the plurality of positions corresponds to an angle ranging between the non-zero angle and a zero angle of at least one of the plurality of attaching elements relative to the horizontal plane.

9. The apparatus of claim 5, wherein at least a portion of each of the plurality of secondary bearings extends beyond the tilt edge based on the attaching of each of the plurality of secondary bearings to each of the plurality of attaching elements respectively.

10. The apparatus of claim 9, wherein each of the plurality of secondary bearings radially supports the mounting plate on each of the plurality of secondary bearings.

11. The apparatus of claim 10, wherein the mounting plate is spaced from the tilt edge by a distance from the tilt edge.

12. The apparatus of claim 1, wherein the rotating assembly further comprises a gear and a drive gear, wherein the motor comprises a stator body and a rotary shaft rotatably engaged with the stator body, wherein the gear is coupled to the second bearing ring, wherein the drive gear is torsionally connected to the rotary shaft, wherein the gear and the drive gear are rotatably engaged.

13. The apparatus of claim 1, wherein the second bearing ring comprises a plurality of gear teeth exteriorly around the second bearing ring, wherein the rotating assembly comprises a drive gear, wherein the motor comprises a stator body and a rotary shaft rotatably engaged with the stator body, wherein the drive gear is torsionally connected to the rotary shaft, wherein the second bearing ring and the drive gear are rotatably engaged.

14. The apparatus of claim 1, wherein the swivel joint element comprises a first joint connector and a second joint connector, wherein the first joint connector and the second joint connector are rotatably connected to each other, wherein the first joint connector is fixedly coupled with the mounting plate, wherein the second joint connector is fixedly coupled to the first bearing ring.

15. The apparatus of claim 1 further comprising a processing unit electronically coupled with the motor.

16. An apparatus for adjustably mounting a solar panel, the apparatus comprising:
a tilt housing comprising a tilt end and a base end, wherein the tilt end and the base end are positioned terminally opposite to each other along the tilt housing, wherein the tilt housing defines an interior space extending between the tilt end and the base end, wherein the tilt housing is circularly cylindrical shaped, wherein the tilt housing comprises a tilt edge defining the tilt end, wherein the tilt edge is beveled;
a primary bearing disposed adjacent to the base end, wherein the primary bearing comprises a first bearing ring and a second bearing ring, wherein the first bearing ring and the second bearing ring are rotatably engaged, wherein the second bearing ring is fixedly coupled to the base end of the tilt housing;
a swivel joint element comprised in the interior space, wherein the swivel joint element is coupled to the first bearing ring;
a mounting plate disposed adjacent to the tilt end, wherein the mounting plate is rotatably coupled with the swivel joint element, wherein the mounting plate is configured for mounting the solar panel on the mounting plate;
a post comprising a first end and a second end, wherein the first end is positioned opposite to the second end along the post, wherein the first end is fixedly coupled to the first bearing ring;
a rotating assembly comprising a motor, wherein the rotating assembly is coupled to the post, wherein the motor is operatively coupled with the primary bearing; and
a plurality of secondary bearings attached around the tilt housing along a line parallel to the tilt edge, wherein the plurality of secondary bearings is configured for orientably supporting the mounting plate rotatably coupled to the swivel joint element.

17. The apparatus of claim 16, wherein the rotating assembly further comprises a gear and a drive gear, wherein the motor comprises a stator body and a rotary shaft rotatably engaged with the stator body, wherein the gear is coupled to the second bearing ring, wherein the drive gear is torsionally connected to the rotary shaft, wherein the gear and the drive gear are rotatably engaged.

18. The apparatus of claim 16, wherein at least one of the plurality of secondary bearings is attached at least one of interiorly and exteriorly around the tilt housing along the line parallel to the tilt edge.

19. The apparatus of claim 16, wherein the post comprises at least one bracket comprised in the first end of the post, wherein the at least one bracket is configured for attaching the tilt housing in at least one orientation in relation to the post, wherein the at least one bracket is configured to be attached to the first bearing ring of the primary bearing for the coupling of the first end to the first bearing ring.

20. An apparatus for adjustably mounting a solar panel, the apparatus comprising:
a tilt housing comprising a tilt end and a base end, wherein the tilt end and the base end are positioned terminally opposite to each other along the tilt housing, wherein the tilt housing defines an interior space extending between the tilt end and the base end, wherein the tilt housing is circularly cylindrical shaped, wherein the tilt housing comprises a tilt edge defining the tilt end, wherein the tilt edge is beveled;
a primary bearing disposed adjacent to the base end, wherein the primary bearing comprises a first bearing ring and a second bearing ring, wherein the first bearing ring and the second bearing ring are rotatably engaged, wherein the second bearing ring is fixedly coupled to the base end of the tilt housing;
a swivel joint element comprised in the interior space, wherein the swivel joint element is coupled to the first bearing ring;
a mounting plate disposed adjacent to the tilt end, wherein the mounting plate is rotatably coupled with the swivel joint element, wherein the mounting plate is configured for mounting the solar panel on the mounting plate;
a post comprising a first end and a second end, wherein the first end is positioned opposite to the second end along the post, wherein the first end is fixedly coupled to the first bearing ring, wherein the post comprises at least one bracket comprised in the first end of the post, wherein the at least one bracket is configured for attaching the tilt housing in at least one orientation in relation to the post, wherein the at least one bracket is configured to be attached to the first bearing ring of the primary bearing for the coupling of the first end to the first bearing ring;
a rotating assembly comprising a motor, wherein the rotating assembly is coupled to the post, wherein the motor is operatively coupled with the primary bearing; and
a plurality of secondary bearings attached around the tilt housing along a line parallel to the tilt edge, wherein the plurality of secondary bearings is configured for orientably supporting the mounting plate rotatably coupled to the swivel joint element.
